(19) United States
(12) Patent Application Publication
(10) Pub. No.: US 2005/0149991 A1
(43) Pub. Date: Jul. 7, 2005

(54) Method and apparatus for finding applications and relating icons loaded on a television

(76) Inventors: Bryan S. Hallberg, Vancouver, WA (US); Mark G. Hanley, Skamania, WA (US)

Correspondence Address: MARGER JOHNSON & MCCOLLOM, P.C. - SHARP, 1030 SW MORRISON STREET, PORTLAND, OR, 97205, US

(21) Appl. No.: 10/966,277

(22) Filed: Oct. 15, 2004

Related U.S. Application Data
(60) Provisional application No. 60/535,044, filed on Jan. 6, 2004.
(60) Provisional application No. 60/535,117, filed on Jan. 6, 2004.

(51) Int. Cl. H04J 3/06; G06F 3/00; H04N 5/445; G06F 13/00; H04N 7/16

(52) U.S. Cl. 725/139; 725/51; 725/60; 725/61; 725/136

(57) ABSTRACT

Succinctly, this invention assumes Java Applets packaged in a jar file, with all of the accompanying classes and resources, as well as one additional file—a descriptor file. This last file can be read from the jar file, and scanned to extract an icon to represent the applet on a menu, the applet's name in market applicable languages, applet size and position, and the applets main class name. No further processing need be done to present this applet to the user for selection. The entire applet need not be loaded into memory until the user requests it. Once the user has selected the application, the applet can be sized and launched without further scanning.

### CROSS REFERENCE TO RELATED APPLICATIONS

This application claims priority from U.S. Provisional Patent Application No. 60/535,044, filed on 6 Jan. 2004, and to U.S. Provisional Patent Application No. 60/535,117, filed on 6 Jan. 2004, which are hereby incorporated by reference in their entirety for all purposes.

### BACKGROUND OF THE INVENTION

1. Technical Field of the Invention

The invention relates to interactive television systems, and more particularly to the methods for operating Java Applets on such televisions.

2. Description of the Related Art

As embedded computers in televisions become more capable, it is inevitable that these computers will be called upon to host multiple applications. Whereas the first applications on computers embedded in televisions processed user input in managing TV settings (traditional menu and on-screen display, or OSD), later applications will mimic the much broader base of functionality found in today's personal computers (PCs). The need is growing for users of future televisions to have access to multiple applications on their TV, and the ability to select and launch them from a standard menu.

There are several drawbacks to cost-effective modern televisions that would limit the ability of users to access available applications. First, TVs have limited processing power as compared to PCs. Second, TVs have limited memory as compared to PCs. Third, National Television System Committee (NTSC) screen resolutions and the TV typical viewing distances will place a practical limitation of one (1) active application on the screen at a time. Fourth, hardware design changes will steer the language of choice for these applications to an interpreted language, such as Java. And fifth, given Java as a language and the limited nature of such a computer, the natural application framework becomes java.applet.Applet

Embodiments of the invention address these and other limitations of the conventional art.

### BRIEF DESCRIPTION OF THE SEVERAL VIEWS OF THE DRAWINGS

The foregoing and other objects, features and advantages of the invention will become more readily apparent from the following detailed description of several preferred embodiments of the invention that proceeds with reference to the accompanying drawings.

FIG. 1 is a block diagram illustrating a possible operating environment for some embodiments of the invention.

FIG. 2 is a block diagram illustrating an example television capable of operating according to some embodiments of the invention.

FIG. 3 is a table showing a descriptor file for an applet implemented with C++ according to some embodiments of the invention.

FIG. 4 is a table showing a descriptor file for an applet implemented with Java according to some embodiments of the invention.

### DETAILED DESCRIPTION OF THE INVENTION

Several preferred embodiments of the invention will now be described with reference to the several views of the drawings. The embodiments described below are not intended to be a complete or exhaustive list of all embodiments of the invention, rather they are used to help explain and elucidate the inventive concepts embraced by embodiments of the invention. It will be recognized that various modifications may be made to the exemplary embodiments described herein yet the modifications will still retain the inventive concepts.

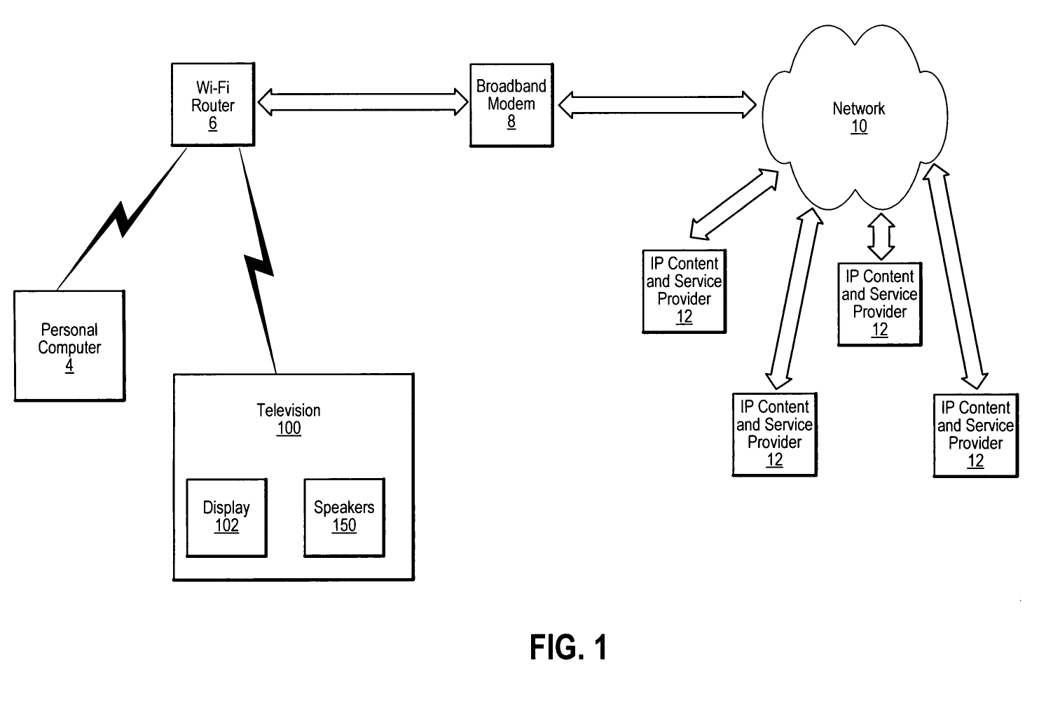

FIG. 1 is a block diagram illustrating an example operating environment for some embodiments of the invention. Television system 100 and personal computer 4 may be wirelessly connected to a Wi-Fi (wireless fidelity) router 6. Wi-Fi is used generically to refer to any type of wireless network, including, but not limited to, an IEEE 802.11 network. For example, a Wi-Fi network may include those defined by the basic IEEE 802.11 specification or extensions to the basic specification such as IEEE 802.11a, IEEE 802.11b, or IEEE 802.11g.

The Wi-Fi router 6 is connected, in turn, to a broadband modem 8, which may be, for example, a cable modem. Broadband modem 8 provides a connection to a network 10. Network 10 may be, for example, the Internet or world wide web. The network 10 may be connected to a number of IP Content and Service Providers 12.

In the operating environment illustrated in FIG. 1, in addition to outputting television broadcasts, the television system 100 may be able to output content received from the personal computer 4 or from the IP Content and Service Providers 12. For example, popular applications for personal computers include gaming, editing digital photos, editing and/or listening to digital audio files such as MP3s (Moving Picture Experts Group, Audio Layer 3) or WMAs (Windows Media Audio), and editing and/or playing digital video. In the operating environment illustrated in FIG. 1, the personal computer 4 may provide this content to the television system 100 for playback. In other words, digital photos may be displayed on the television system 100 and digital audio and/or digital video may be streamed from the PC for playback on the audio and/or display subsystems of television system 100.

The television system 100 may also output content provided from the numerous IP content and service providers 12 by virtue of its connection to the network 8. For example, the user of the personal computer 4 would normally listen to and/or view content from the IP content and service provider 12 with the display and/or speakers that are part of the personal computer 4. However, in this operating environment the user may also listen to and/or view the same audio and/or video content received over the network 8 using the display 102 and speakers 150 of the television system 100.

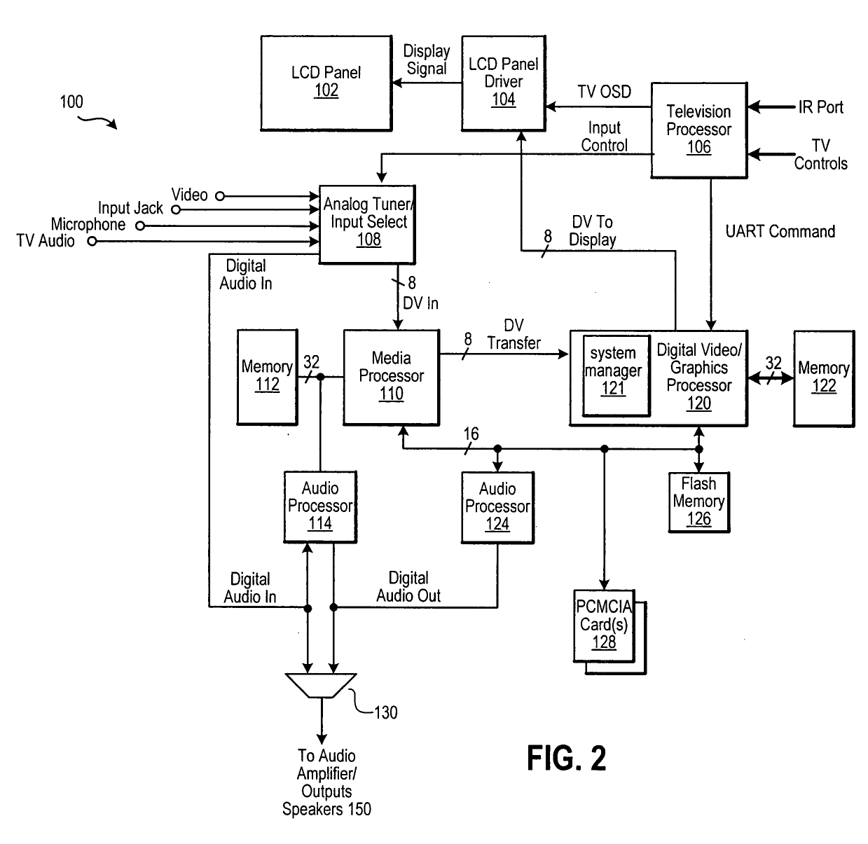

FIG. 2 is a block diagram illustrating an example television system 100 capable of operating according to some embodiments of the invention. In this example, television system 100 is a Liquid Crystal Display (LCD) television. The television system 100 contains an LCD panel 102 that displays visual output to a viewer based on a display signal generated by an LCD panel driver 104. LCD panel driver 104 accepts a primary digital video signal in CCIR656 format (eight bits per pixel YC_{b}Cᵣ, in a “4:2:2” data ratio wherein two C_{b} and two Cᵣ pixels are supplied for every four luminance pixels) from a digital video/graphics processor 120.

A television processor 106 provides basic control functions and viewer input interfaces for television system 100. Television processor 106 receives viewer commands, both from buttons located on the television itself (TV controls) and from a handheld remote control unit (not shown) through the IR Port. Based on the viewer commands, television processor 106 controls an analog tuner/input selector 108, and also supplies user inputs to a digital video/graphics processor 120 over a Universal Asynchronous Receiver/Transmitter (UART) command channel. Television processor 106 is also capable of generating basic On-Screen Display (OSD) graphics, e.g., indicating which input is selected, the current audio volume setting, etc. Television processor 106 supplies these OSD graphics as a TV OSD signal to LCD panel driver 104 for overlay on the display signal.

Analog tuner/input selector 108 allows television system 100 to switch between various analog (or possibly digital) inputs for both video and audio. The video input may include one or more of a radio frequency (RF) signal carrying broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

Analog tuner/input selector 108 also selects an audio source, digitizes that source (if necessary) using an internal A/D converter (not shown), and supplies that digitized source as Digital Audio In to an Audio Processor 114 and a multiplexer 130. Digitization of the source may not be necessary if it is already supplied to the analog tuner/input selector 108 in digital form.

The audio source may be selected-independent of the current video source—as the audio channel(s) of a currently tuned RF television signal, stereophonic or monophonic audio connected to television system 100 by audio jacks corresponding to a video input, or an internal microphone. These audio sources are represented in FIG. 2 by TV audio, input jack, and microphone, respectively. Since the microphone typically has a relatively low signal amplitude, the output of the microphone is usually passed through an amplifier stage before being sent to the source selection switch (not shown) in the analog tuner/input select section 108.

Media processor 110 and digital video/graphics processor 120 provide various digital feature capabilities for television system 100. In some embodiments, processors 110 and 120 can be TMS320DM270 signal processors, available from Texas Instruments, Inc., Dallas, Texas. Digital video/graphics processor 120 functions as a master processor, and media processor 110 functions as a slave processor. Digital video/graphics processor 120 includes the system manager 121, which will be explained in further detail below. Media processor 110 supplies digital video, either corresponding to DV In or to a decoded media stream from another source, to digital video/graphics processor 120 over a DV transfer bus.

Media processor 110 may perform MPEG (Motion Picture Expert Group) coding and decoding of digital media streams for television system 100, as instructed by digital video/graphics processor 120. A 32-bit-wide data bus connects memory 112, e.g., two 16-bit-wide×1 M synchronous Dynamic Random Access Memory (DRAM) devices connected in parallel, to processor 110. The audio processor 114 is also connected to this data bus to provide audio coding and decoding for media streams handled by media processor 110. Digital video/graphics processor 120 coordinates (and/or implements) many of the digital features of television system 100. A 32-bit-wide data bus connects memory 122, e.g., two 16-bit-wide×1M synchronous DRAM devices connected in parallel, to processor 120. Although the embodiments of the invention shown in FIG. 2 utilize DRAM memory devices, other embodiments of the invention may be implemented with other memory types, for example, synchronous dynamic random access memory (SDRAM) devices. Furthermore, memory 112 and memory 122 need not be volatile memory. For example, alternative embodiments of the invention may be implemented using static random access memory (SRAM). Other embodiments of the invention may not even utilize silicon-based memory. For example, alternative embodiments of the invention may be implemented with disk-based technology or any other storage technology.

A 16-bit-wide system bus connects processor 120 to media processor 110, an audio processor 124, flash memory 126, and removable PCMCIA (Personal Computer Memory Card International Association) cards 128. Flash memory 126 stores boot code, configuration data, executable code, and Java code for graphics applications, etc. PCMCIA cards 128 can provide extended media and/or application capability. Digital video/graphics processor 120 can pass data from the DV Transfer bus to LCD panel driver 104 as is, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input selector 108. The second and third sources are the Digital Audio Outputs of audio processors 114 and 124. These outputs of audio processors 114 and 124 are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

In digital video/graphics processor 120, the system manager 121 is responsible for the basic operation of television system 100, including locating and extracting the various applet files upon user request as described in more detail below. In the embodiments illustrated in FIG. 2, system manager 121 resides on the Digital Video/Graphics Processor 120.

The applets may be stored for retrieval by the system manager 121 in various memory systems of television system 100, including memory 112 and 122, flash memory 126, or on PCMCIA cards 128.

According to embodiments of the invention, every program installed on the television system 100, whether a system service or Graphic User Interface (GUI) application program, has an associated program descriptor file. The program descriptor files provide the connection between prorograms installed on memory 112 or 122, flash memory 126, or PCMIA card 128 of the television system 100 and the system manager 121 residing on the digital video/graphics processor 120. The program descriptor file enables the system manager to locate the program's executable, privileges, process priority level, and other parameters necessary to incorporate the program into the television system 100.

The program descriptor files may be ASCII text files which may be created using any ASCII text editor. Each program descriptor file consists of a number of text lines, and the file contents may be case sensitive. The contents of a descriptor file according to some embodiments of the invention are listed, by line, in Table 1 below.

TABLE 1

| Line | Label | Use |
|---|---|---|
| 1 | Executable_path: | program's executable path |
| 2 | Unfocused_icon_path: | program's GUI unfocused icon |
| | | path |
| 3 | Focused_icon_path: | program's GUI focused icon |
| | | path |
| 4 | Program_flags: | program's system flags |
| 5 | Interface_types: | program's interface types |
| 6 | System_interface: | program's system interface |
| 7 | Privileges: | program's privileges |
| 8 | Process_priority: | program's process priority |
| 9 | Private_key: | program's private security key |
| | | index |
| 10 | Public_key: | program's public security key |

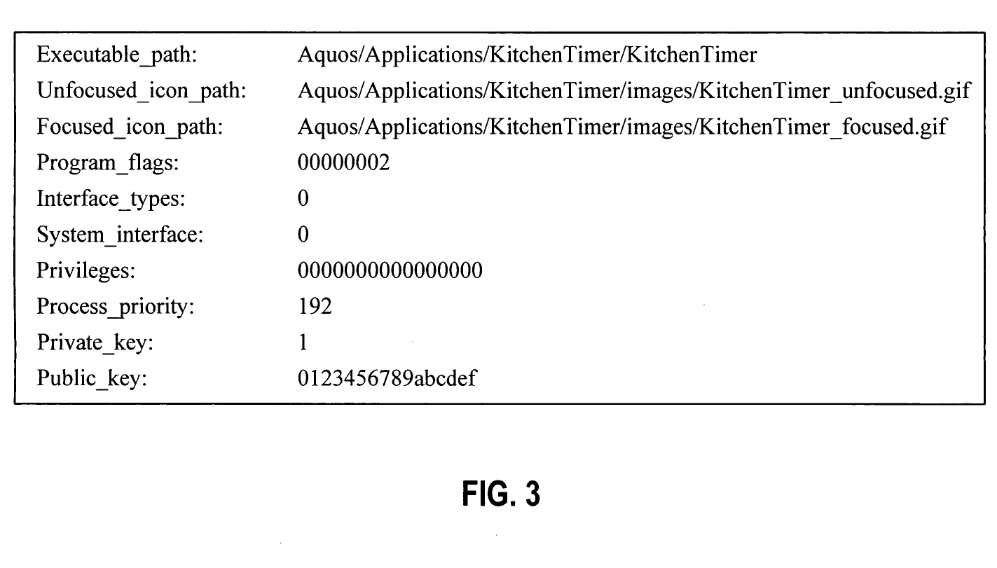

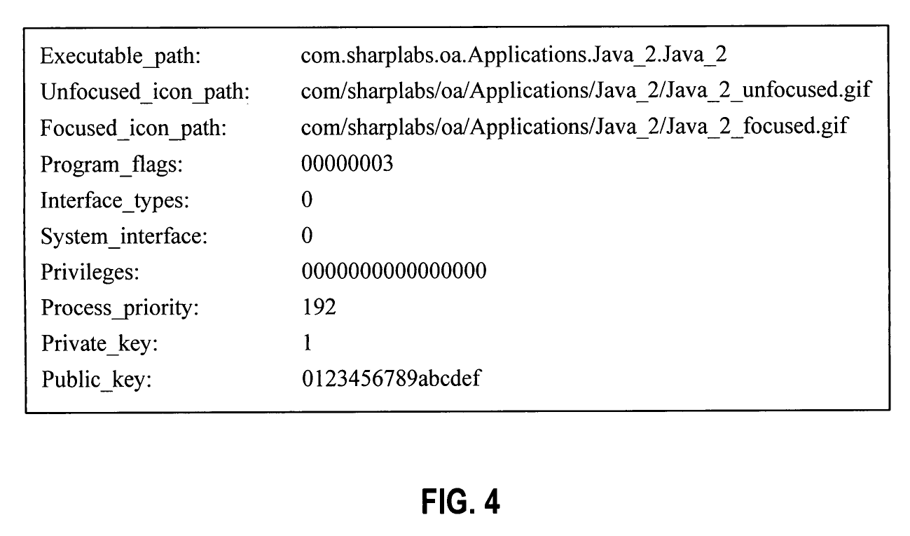

FIG. 3 is a table showing a descriptor file for an applet implemented according to some C++ embodiments of the invention. FIG. 4 is a table showing a descriptor file for an applet implemented according to some Java embodiments of the invention. The C++ descriptor file of FIG. 3 and the Java descriptor file of FIG. 4 are both formatted in keeping with Table 1 above.

Referring to Table 1, the program's system flags (line 4) and the program's interface types (line 5) may be defined in a header file (having a .h extension) that is separate from the program descriptor file. The values for the privileges line (line 7) may be defined in another header file (having a .h extension) that is separate from the program descriptor file. The interface types line contains the list of all interfaces supported by the program. In some embodiments of the invention, the last entry of the interface types line is 0.

The system manager 121 and associated graphic user interface, operable on television system 100, functions to present the user with all possible user selectable programs that the user may run, and enable the user to navigate through the programs and select and run their desired program. The user may also sort the program icons so that their favorite program icons are displayed first, allowing quick access to the user's favorite programs.

Preferred embodiments of the invention modify the <object> tag format for hyper-text markup language (html) as defined by Section 13.3 of HTML Specification 4.01, World Wide Web Consortium (W3C) Recommendation, 24 Dec. 1999, since that is a common launching pad for applets. HTML Specification 4.01 may presently be found at the following URL—http://www.w3.org/TR/html401/. Throughout the rest of this disclosure, the HTML 4.01 Specification will simply be referred to as HTML 4.01. HTML 4.01 is hereby incorporated by reference for all purposes.

From HTML 4.01:
<!ELEMENT OBJECT - - (PARAM | %flow;)*
-- generic embedded object →
<!ATTLIST OBJECT

| | | | | |
|---|---|---|---|---|
| %attrs; | | | -- | %coreattrs, %i18n, %events - |
| declare | (declare) | #IMPLIED | -- | declare but don't instantiate |
| flag | | | | |
| -- | | | | |
| classid | %URI; | #IMPLIED | -- | identifies an implementation - |
| codebase | %URI; | #IMPLIED | -- | base URI for classid, data, |
| archive- | | | | |
| data | %URI; | #IMPLIED | -- | reference to object's data - |
| type | %ContentType; | #IMPLIED | -- | content type for data - |
| codetype | %ContentType; | #IMPLIED | -- | content type for code - |
| archive | CDATA | #IMPLIED | -- | space-separated list of URIs - |
| standby | %Text; | #IMPLIED | -- | message to show while loading - |
| height | %Length; | #IMPLIED | -- | override height - |
| width | %Length; | #IMPLIED | -- | override width - |
| usemap | %URI; | #IMPLIED | -- | use client-side image map - |
| name | CDATA | #IMPLIED | -- | submit as part of form - |
| tabindex | NUMBER | #IMPLIED | -- | position in tabbing order - |
| > | | | | |

Embodiments of the invention optimize the above <object> tag format based upon the embedded target environment. For example, the embedded target environment may be the television system 100 of FIG. 2. This optimization is accomplished by removing or ignoring some attributes that are deemed unnecessary for describing the associated program application, and adding other attributes that are considered useful for describing the associated program application.

As one example, the height and width attributes are retained, the classid attribute is simplified, and additional attributes are added. The added attributes include attributes x and y (which are implied in the placement of the <object> tag in html), an icon path attribute, and English, Spanish, and French attributes each containing a text string to name the applet in English, Spanish and French. The English, Spanish, and French attributes would be beneficial for television systems 100 that are destined for the North American market. Other similar features may be added depending on the local, regional, or continental markets where the television systems will be sold. The remaining attributes (from HTML 4.01) are deemed unnecessary and thereby removed or ignored.

The modified .jad (java application descriptor) according to the example embodiment described above would read as follows:

```
<object codetype=”application/java”
    classid=”java:AMBApplet”
    icon=”images\memo.gif”
    English=”AudioMessageBoard”
    espanol=”AMBApp[s]”
    francais=”AMBApp[f]”
    x=”0”
    y=”0”
    width=”640”
    height=”480”>
</object>
```

Parameters may be added as per HTML 4.01 above. With this program descriptor file added to an applet (usually in a jar, or java archive file), embodiments of the invention can scan this file, and extract just enough information to represent the applet to the user (icon and applet name). Then if the user wishes to invoke the applet, the rest of its extraction from the jar file can occur per the normal class loading mechanism.

This .jad format has the advantage of being human readable, and relatively small in size. A speed optimized version is also available that is tailored for the Java class StringTokenizer.class which expects a character delimited string. This option removes most of the parsing, and so is faster, but suffers from a human readability standpoint. The modified jad described above would appear as follows in “speed optimized” form:

AMBApplet;images\memo.gif;AudioMessageBoard;AMBApp[s];AMBApp[f];0;0;640;480

According to embodiments of the invention, the program descriptor files described above may be scanned by the system manager 121 to extract an icon to represent the applet on a menu screen, the applet's name in market applicable languages, the applet size and position, and the applets main class name. No further processing need be done to present this applet to the user for selection.

Consequently, there is no need to load the entire applet into memory until the user requests it. Once the user has selected the application, the applet can be sized and launched by the system manager 121 without further scanning.

Having described and illustrated exemplary embodiments of the invention, it should be apparent that the described embodiments can be modified in arrangement and detail without departing from the principles of the invention. We claim all modifications and variations coming within the spirit and scope of the appended claims.

1. A television system comprising:
a processor having a system manager;
a memory coupled to the processor, the memory storing a plurality of programs and a plurality of program descriptor files, each program descriptor file corresponding to a program;
a display responsive to the processor.

2. The television system of claim 1, each program descriptor file containing parameters necessary to incorporate the corresponding program into the television system.

3. The television system of claim 2, each program descriptor file comprising one chosen from a java archive file and an ASCII text file.

4. The television system of claim 1, the system manager configured to cause an icon and a name of a program to be displayed on a menu screen after scanning a corresponding program descriptor file.

5. The television system of claim 4, the system manager configured to load the program completely into the memory after the icon on the menu screen is selected.

6. The television system of claim 1, the memory selected from the group consisting of a DRAM device, a SRAM device, a SRAM device, a flash memory, and a PCMCIA card.

7. The television system of claim 1, the display comprising a liquid crystal display.

8. The television system of claim 1, the program comprising one chosen from a system service program and an application program.

9. The television system of claim 8, the program further comprising one chosen from a Java applet and a C++ applet.

10. A method comprising:
optimizing the HTML object tag format of a program application installed on a television system to obtain an associated program descriptor file.

11. The method of claim 10, wherein optimizing the HTML object tag format comprises removing an attribute that does not describe the program application.

12. The method of claim 11, wherein optimizing the HTML object tag format further comprises adding an attribute that describes the program application.

13. The method of claim 10, further comprising extracting an icon and a name from the associated program descriptor file to display using the television system.

14. The method of claim 13, further comprising loading the program application into a memory when the icon and the name is selected.

15. The method of claim 10, wherein optimizing the HTML object tag format of a program application comprises optimizing the HTML object tag format of an applet installed on the television system to obtain a java application descriptor file.

16. The method of claim 15, wherein the java application descriptor file is tailored to a java class that expects a character delimited string.

17. A machine readable medium that, when read, causes a television system to perform processes comprising:
optimizing the HTML object tag format of a program application installed on the television system to obtain an associated program descriptor file.

18. The medium of claim 17, wherein optimizing the HTML object tag format comprises removing an attribute that does not describe the program application.

19. The medium of claim 18, wherein optimizing the HTML object tag format further comprises adding an attribute that describes the program application.

20. The medium of claim 17, further comprising extracting an icon and a name from the associated program descriptor file to display using the television system.

21. The medium of claim 20, further comprising loading the program application into a memory when the icon and the name is selected.

22. The medium of claim 17, wherein optimizing the HTML object tag format of a program application comprises optimizing the HTML object tag format of an applet installed on the television system to obtain a java application descriptor file.
